(19) United States
(12) Patent Application Publication
(10) Pub. No.: US 2016/0081373 A1
(43) Pub. Date: Mar. 24, 2016

(54) Methods and Systems for Altering the Molecular Structure of a Liquid

(71) Applicants: Michael Coyne, Spokane, WA (US); Charles G. Leonhardt, Huntington, NY (US)

(72) Inventors: Michael Coyne, Spokane, WA (US); Charles G. Leonhardt, Huntington, NY (US)

(21) Appl. No.: 14/861,871

(22) Filed: Sep. 22, 2015

Related U.S. Application Data
(60) Provisional application No. 62/054,206, filed on Sep. 23, 2014.

(51) Int. Cl. A23L 1/025; A23L 3/015

(52) U.S. Cl. CPC A23L 1/0252; A23L 3/0155; A23V 2002/00

(57) ABSTRACT

This disclosure describes methods, devices, and systems for introducing cavitations into a liquid. In some implementations, the methods and devices allow for small batch processing of a liquid with a transducer, which introduces ultrasonic energy into the liquid causing cavitations. In some instances, the cavitations may fragment or degrade compounds within the liquid and enhance the quality of the liquid. This disclosure also describes methods and systems of introducing cavitations into a liquid via a continuous flow system to process a large quantity of liquid.

### CROSS REFERENCE TO RELATED APPLICATION

This application claims priority to U.S. Provisional Patent Appln. No. 62/054,206 filed Sep. 23, 2014, entitled “Method and Systems for Altering the Molecular Structure of Consumable Liquids,” the entirety of which is incorporated herein by reference.

### BACKGROUND

Many liquids such as wine and distilled spirits, among others, require an extensive amount of time to age until the liquid has a suitable taste. In many cases, these liquids along with fruit juice, oils, and so forth require additives to enhance flavor, prolong shelf life, and preserve the liquid. Both the extensive amount of time to age and the addition of additives to the liquid may have detrimental effects in terms of production costs and, in some cases, health side effects to the consumer. For instance, additives may be added to a liquid to kill extraneous bacteria that, in some instances, form harmful microscopic noxious vaporous gases when ingested and can cause severe discomfort. Therefore, methods, devices, and systems to reduce the time required to age a liquid and reduce the addition of additives by breaking down the structure of the additives is needed.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a first environment to alter molecular structures in a liquid in a small batch.

FIG. 2 illustrates a second environment to alter molecular structures in a liquid in a small batch.

FIG. 3 illustrates a third environment to alter molecular structures in a liquid in a small batch.

FIG. 4 illustrates a fourth environment to alter molecular structures in a liquid in a small batch.

FIG. 5 illustrates an example device to alter molecular structures in a liquid in a small batch.

FIG. 6 illustrates another example device to alter molecular structures in a liquid in a small batch.

FIG. 7 illustrates a perspective view of the example device shown in FIG. 6.

FIG. 8 illustrates a first environment to alter molecular structures in a liquid in a continuous flow system.

FIG. 9 illustrates a second environment to alter molecular structures in a liquid in a continuous flow system.

FIG. 10 illustrates a third environment to alter molecular structures in a liquid in a continuous flow system.

FIG. 11 illustrates a fourth environment to alter molecular structures in a liquid in a continuous flow system.

FIG. 12 illustrates a cross-sectional view of a first implementation of a liquid altering device.

FIG. 13 illustrates a cross-sectional view of a second implementation of a liquid altering device.

FIG. 14 illustrates additional cross-sectional views of a liquid altering device.

FIG. 15 illustrates a plurality of transducers positioned in a triangular arrangement within an example liquid altering device.

FIG. 16 illustrates a transducer suspended within an example liquid altering device.

FIG. 17 illustrates a plurality of transducers banked within an example liquid altering device.

FIG. 18 illustrates a plurality of transducers positioned along the bottom of an example liquid altering device.

FIG. 19 illustrates an embodiment of a multiple bottle device for altering a molecular structure of liquids.

FIG. 20 illustrates an example device to alter molecular structures in a liquids in multiple bottles.

FIG. 21 illustrates a flow graph showing an example process of altering molecular structures in liquids in a small batch embodiment.

FIG. 22 illustrates a flow graph showing an example process of altering molecular structures in liquids in a flow through or large batch embodiment.

### DETAILED DESCRIPTION

### Overview

This disclosure describes methods, devices, and systems for altering a liquid. In some implementations, the liquid may include wine (e.g., red wine, white wine, rosé, etc.), fortified wine, liquor (e.g., scotch whisky, bourbon whiskey, tequila, vodka, gin, rum, etc.), liqueur, fruit juice (e.g., orange juice, apple juice, grape juice, pineapple juice, or combinations thereof), coffee, tea, oil (e.g., olive oil, peanut oil, sesame oil, or other plant-based oils), vinegar (e.g., balsamic vinegar, cider vinegar, malt vinegar, etc.), herb extracts, honey, molasses, dairy products (e.g., milk, cream, etc.), or a combination thereof. The liquid may contain any number of compounds or additives. For instance, the liquid may contain esters, tannins, pseudo tannins (e.g., gallic acid, flavan-3-ols, chlorogenic acid, ipecacuanhic acid), polycyclic aromatic hydrocarbons, sulfites, sulfur dioxide, other dissolved or undissolved gases, tartaric acid, malic acid, phenols, polyphenols, sugars, anthocyanins, flavonoids (e.g., quercetin), enzymes, preservatives (e.g., benzoic acid, sodium benzoate, sorbic acid, sodium sorbate, citric acid, ascorbic acid, tocopherol, lactic acid, etc.) and the like. One of ordinary skill in the art will understand the vast number of compounds that may be present in a liquid such as those listed above. In addition, the methods, devices, and systems described herein can be used in connection with liquids with varying viscosities and/or temperatures.

In some implementations, the disclosure describes methods and devices for altering the molecular structure of a small batch (e.g., a bottle or multiple bottles holding from about 0.184 liters to about 18 liters of liquid, or a container or multiple containers holding from about 3 ounces to about 26 ounces of liquid). In some implementations, the method can include placing one or more transducers (i.e., ultrasonic transducers) within a proximity of and in acoustic communication with the small batch of liquid. In some implementations, the transducer may be coupled to a water bath holding the liquid. The transducers can accept electrical energy from a generator designed to work with the transducer and the loaded environment (e.g., liquid coupling medium, pad, bladder, bottle, etc.) to produce ultrasonic excursions or ultrasonic frequencies. In some implementations, the amount of electrical energy supplied to the transducers may be from about 500 watts to about 1,500 watts or from about 600 watts to about 1,000 watts.

In some implementations, the amount of ultrasonic energy produced by the transducers may be adjusted based on characteristics of the liquid. These characteristics may include viscosity, type, number of identified compounds, temperature, etc. The ultrasonic frequency produced by the transducer may be above a threshold and may create cavitations (i.e., vapor cavities) in the liquid. The vapor cavities can be formed when the ultrasonic energy breaks down compounds and/or molecules in the liquid (such as those described above), which can create and release vaporous gases. These vaporous gases can agglomerate into cavitations, which can be nanometer sized. In some implementations, the cavitations produced by the ultrasonic energy may enhance flavor by breaking down compounds or cells not released during normal processing of the liquid and/or prolong stability of the liquid. By way of example, the methods, devices, and systems described herein may increase the shelf-life of wine by 10 or more days after the bottle is opened. In some implementations, modification of protein structures within the liquid can occur, which may improve a taste, aroma, stability, and color of a liquid. In some implementations, using the method described herein may allow for fewer preservatives to be used to accomplish the purpose of extending shelf life. In some implementations, the pH of the liquid may be reduced. Altering the liquid as described herein may improve sensory, digestive, or medicinal results of the liquid.

For example, using wine as a consumable liquid, a 750 ml bottle of Washington Cabernet Sauvignon wine can be processed by the methods and devices disclosed herein for approximately 20 minutes at 40 kHz. Before processing, the pH of the wine was 3.58. After processing, the pH was 3.52 and the taste of the wine noticeably improved.

In another example, using whiskey as a consumable liquid, a 50 gallon Washington Rye Whiskey that would normally be aged 2-3 years longer than when the sample was taken was processed using a 1,050 watt continuous flow system (described in more detail below) at 20 kHz at a flow rate of 10 gallons per minute. Before processing, the pH of the whiskey was 4.19. After processing the pH was 4.06.

The time period for which liquid can be exposed to ultrasonic energy to reach the results described herein may differ depending on the type, volume, and/or other characteristic (e.g., viscosity, temperature, etc.) of liquid being processed. For example, a bottle of wine may be processed for 5 to 30 minutes, or from 7 to 10 minutes, using the methods described herein.

The methods, devices, and systems described herein may not eliminate or add to what was originally in the liquid. In some implementations, the methods, devices, and systems may permanently alter a molecular configuration of the liquid.

This disclosure also describes methods and systems for altering the molecular structure of a liquid with a continuous flow (i.e., large batch) system. In some implementations, the system may include an exposure container having one or more transducers in acoustic communication with the exposure container. The liquid may be pumped through the exposure container by a pump, such as for example a variable speed pump, from a source container to a finishing or target container. In some implementations, the rate of flow of the liquid through the exposure container may be varied by, for example, a flow valve. In other implementations, the liquid may be moved through the system by an apparatus or method other than a pump. For instance, the system may include a vacuum such that the liquid is pulled through the exposure container. In another example, gravity may be used to move the liquid through the described system. Finally, any combination of the described pump, vacuum and/or gravity can be used in combination.

As mentioned above, the one or more transducers may produce cavitations in the liquid as it flows through the exposure container. The one or more transducers may break down and release vaporous gases, or in some cases liquefy, and agglomerate the gases as mentioned above. In some implementations, the one or more transducers may be angled or aimed in a direction that is deviated from the directional flow of the liquid, which may intensify the break down and release of vaporous gases or alter the cavitations.

The cavitations may exhibit a temperature and pressure that is greater than the temperature and pressure of the surrounding liquid. The frequency at which the transducers produce ultrasonic energy may be varied. Additionally, the size of the cavitations may change based on the ultrasonic frequency, and the temperature and pressure within each of the cavitations may also change based on the ultrasonic frequency. For instance, at greater frequencies of ultrasonic energy the pressure within each of the cavitations may be greater and/or small cavitations may occur. However, as frequency increases there may be fewer cavitations. Additionally, lower frequencies of ultrasonic energy produced by the transducers may result in larger cavitations with a lower internal pressure. In some cases, lower ultrasonic frequencies with a greater wavelength and larger cavitation bubble may not exceed a first threshold of energy needed to create the optimum cavitations, yet cavitations may also be absent at higher frequencies above a second threshold. In some cases, lower frequencies with longer wavelengths may leave areas of the liquid unprocessed.

In some implementations, the compounds and molecules mentioned above may be captured within or upon the cavitations. In some instances, the pressure and temperature associated with the cavitations may fragment or otherwise alter the compounds and molecules. In some instances, the fragmented or altered compounds may release flavors that would normally be contained within their molecular structure.

In other implementations, the continuous flow system may include a degassing container, especially if the system is processed under a pressure. The degassing container may be described as a degassing mechanism, which can be, for example, a degassing opening in the exposure container or other components of the system. In some instances, the degassing container may allow the release of gases (sulfur dioxide, nitrogen, etc.) introduced to preserve the liquid. In some applications, the degassing mechanism may or may not contain additional ultrasonic transducers and be energized at a frequency above the threshold of cavitation at the same, or different, frequencies as the flow through processing chamber. In other implementations, the continuous flow system may include other containers that may introduce flavors or other additives to the liquid either prior to the exposure container or after the exposure container. For instance, the system may include a container having wood chips, which may add specific flavor characteristics to the liquid.

In another implementation, one or more transducers may be placed proximate to the container holding the liquid. In some implementations, the transducers may be hung within the container and immersed in the liquid. In other implementations, the transducers may be arranged in one or more arrays that may maximize the effects of the ultrasonic energy on the liquid.

The implementations described above may significantly reduce an amount of wait time a liquid may generally require to reach its peak or optimized flavor. For instance, wine or whiskey may require an extensive amount of wait time in wooden casks or barrels to mature (i.e., breakdown and release flavor-preferred compounds or molecules) to acquire a desired flavor characteristic. However, the controlled cavitations produced by the ultrasonic energy of the transducer in the methods, devices, and systems disclosed herein may greatly accelerate this maturation process. Furthermore, the methods, devices, and systems described herein may enhance the desirable characteristics (e.g., flavor, smell, etc.) of the liquid.

In the implementations described herein (i.e., small batch processing or continuous flow through processing) the transducer(s) may be programmed to produce a frequency from about 10 kHz to about 120 kHz, or from about 20 kHz to about 50 kHz, or from about 30 kHz to about 45 kHz, or from about 40 kHz to about 42 kHz. In some implementations, as frequency increases, fewer cavitations may be available and may require more energy to create cavitations.

In some embodiments, the devices described in the present disclosure can be used in the creation of liposomal liquid compounds. For example, plant-based components may be combined with lecithin (fatty substance occurring in animal and plant tissues) and water or other effective liquids. These components may be mixed together and exposed to the frequencies described herein, such as ultrasonic frequencies. This sonication may create a stable fat-encapsulated composition, which may be described as a micro-nutrient. The micro-nutrient may be ingested and may increase the uptake and bioavailability of the micro-nutrient for human and animal treatments.

Additionally, the devices described in the present disclosure can be used to extract compounds from plant-based tissues. For example, a plant-based material may be added to one or more liquid surfactants in the devices described herein. Ultrasonic energy can be directed toward the plant-based material, and heat may be applied. This process may cause materials within the plant-based tissue to breakdown or otherwise be altered. Certain compounds in the plant-based tissue may be released from the plant-based tissue, or may be retained within the plant-based tissue. Use of ultrasonic energy as described herein may increase the availability of active ingredients in the plant-based tissue, or cause those active ingredients to be more readily removed from the plant-based tissue. The availability of the active ingredient may be increased by 60% or more than availability of the active ingredient without use of ultrasonic energy.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” “contain,” “including,” “includes,” “include,” and “have” have the same open-ended meaning as “comprising,” “comprises,” and “comprise” provided above.

The term “about” or “approximate” as used in the context of describing a range of volume or frequency is to be construed to include a reasonable margin of error that would be acceptable and/or known in the art.

The present description uses numerical ranges to quantify certain parameters relating to the innovation. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds) and provided literal support for and includes the end points of 10 and 100.

The present description uses specific numerical values to quantify certain parameters relating to the innovation, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. These broad, intermediate, and narrow numerical ranges should be applied not only to the specific values, but should also be applied to differences between these specific values.

This overview, including section titles, is provided to introduce a selection of concepts in a simplified form that are further described below. The overview is provided for the reader's convenience and is not intended to limit the scope of the implementations or claims, nor the proceeding sections.

### Example Small Batch Methods and Devices

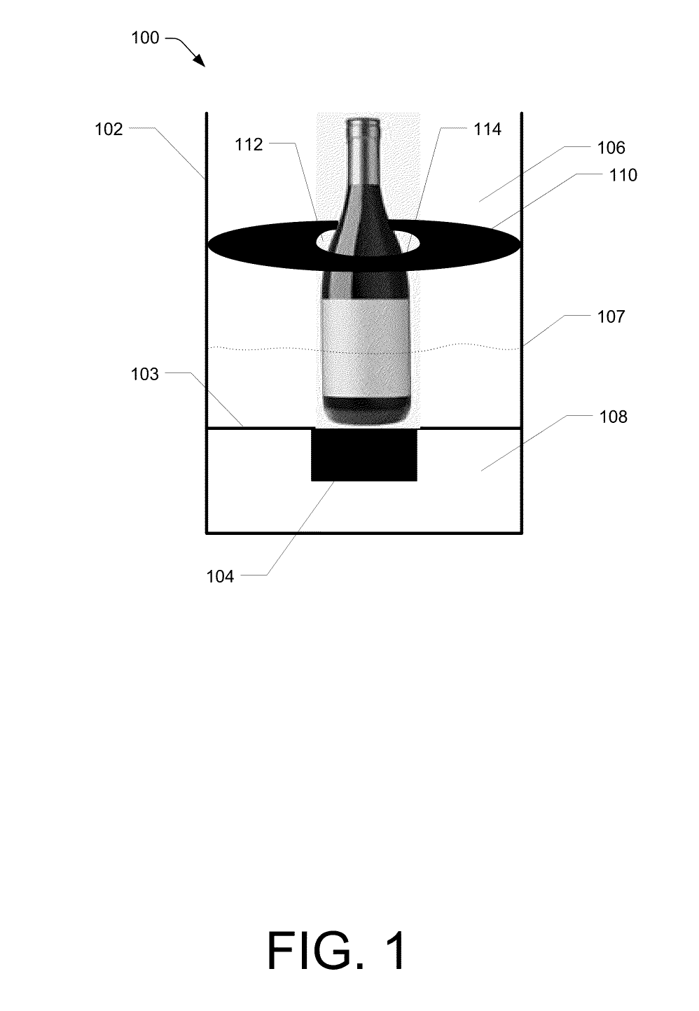

FIGS. 1-4 illustrate various environments to alter molecular structures of a liquid. Each of the environments of FIGS. 1-4 may alter molecular structures of a small batch of liquid, such as, for example, a 750 mL bottle of wine. However, the environments described of FIGS. 1-4 may also be suitable for a number of bottles of liquid, such as, for example, two, four, six, eight, ten, or more 750 mL wine bottles.

In small batch treatment of liquids, time of exposure to cavitations may be critical due to potential heat buildup. In some implementations, the small batch environments described below and shown in FIGS. 1-4 may be configured such that the transducer produces an initial pulse of ultrasonic energy before a continuous ultrasonic frequency is produced. Providing an initial pulse in this way may allow gases to escape capture in a continuous wave of ultrasonic energy and rise to the surface of the liquid to be expelled. The initial pulse may also provide momentarily higher delivery of energy, potentially reducing the time of exposure needed by the continuous ultrasonic energy. In some instances, exposure time to the ultrasonic energy may vary from about 5 milliseconds to about 20 minutes or longer, or from about 5 minutes to about 15 minutes.

Turning now to the figures, FIG. 1 illustrates an environment 100 to alter molecular structures of a small batch of liquid. Environment 100 includes a housing 102 defining an at least partially hollow interior capable of holding a number of instruments to produce the cavitations described above and alter the molecular structure of the liquid. In some implementations, housing 102 may be made of plastic, metal, or a combination thereof. A partition component 103 may divide the housing into a first chamber 106 and a second chamber 108. The first chamber 106 and the second chamber 108 may be of varying sizes and may be the same or different sizes than each other. The first chamber 106 may be sized to receive a liquid-containing vessel, such as the wine bottle depicted in FIG. 1. One or more transducers 104 capable of producing an ultrasonic frequency can be situated at least partially within the second chamber 108 and can be in acoustic communication with the liquid-containing vessel when the liquid-containing vessel is received within the first chamber 106. In some implementations, the first chamber 106 may be configured to hold a liquid coupling medium. In some implementations, the liquid coupling medium may be water. For instance, the dashed line 107 shown in FIG. 1 illustrates an example volume line of a liquid coupling medium in the first chamber 106. In some implementations, the first chamber 106 includes a measuring indication line to allow the user to see whether the first chamber 106 includes an appropriate volume of the liquid coupling medium. In some implementations, a volume of the liquid coupling medium ranges from about 2 ounces to any volume of liquid, including but not limited to multiple liters.

FIG. 1 shows that the liquid may be processed in a liquid-containing vessel (such as a wine bottle). In some implementations, ultrasonic energy from the transducer 104 can readily be transmitted through the liquid coupling medium and the low acoustic impedance of the glass bottle to cause the cavitations as described above. In some implementations, the ultrasonic energy from the transducer 104 may be transmitted directly through the liquid-containing vessel to cause the cavitations as described above.

In some implementations, the frequency of the transducer 104 may be fixed for a period of time. In other implementations, the frequency may step up or step down over a period of time, or otherwise be variable. Alternatively or additionally, the frequency of the transducer 104 may sweep (i.e., progressively vary) between different frequency ranges over a specific predetermined period of time. In some implementations, the frequency of the transducer 104 may be preset for specific liquids based on characteristics of the liquids. For instance, red wine may generally require a greater frequency (i.e., higher pressure associated with the cavitations) and/or a greater period of cavitation formation in order to optimize flavor characteristics, while white wine may require a lesser frequency or less processing time. In some implementations, the device may be configured to produce from about 10 kHz to about 120 kHz, from about 20 kHz to about 50 kHz, from about 30 kHz to about 45 kHz, or from about 40 kHz to about 42 kHz. In some implements, the ultrasonic energy may be turn off for some period of time, such as, for example, a millisecond. By doing so, undissolved and entrapped gasses may be released to and dispersed on the surface of the liquid. This burst of ultrasonic energy may also utilize the greater excursion phenomena of piezoelectric transducers when such a burst of energy is applied.

Using wine as an example consumable liquid, wine can be a very complex liquid comprised of over 250 identifiable compounds and over 160 esters. To reach the consumption readiness state, wine may go through a time consuming maturation and aging process that is characterized by a long-term interaction, or chemical reaction, of its many components. The interaction eventually reaches an optimum state (i.e., “peak bouquet”), after which the interaction results in a deterioration of flavor. Using the method of directing ultrasonic energy into the consumable liquid to generate cavitations with the device shown in FIG. 1, the one or more transducers 104 may break down the many compounds described above, release vaporous gases, and/or agglomerate the gases to generate cavitations. This process can result in enhanced flavor and/or prolonged stability for the consumable liquid.

This disclosure is not intended to be limited to wine. The methods of producing cavitations, and the devices and systems disclosed herein, may be applied to other liquids such as but not limited to, orange juice. In such an application, many of the microscopic compounds that appear in wine also exist in orange juice. As mentioned above, many of the flavorful compounds captured within pulp and cells are not released through normal processing but may be released using the methods, devices, and systems described herein.

In some instances, ripening of fruits can be somewhat analogous to aging of wine. Once the fruit is fully ripened to a stage where it is flavorful, it can quickly pass through a period of peak bouquet and begin to deteriorate or ferment thereafter. Without preservatives, freezing, or running through a concentration process, the fruit can have a comparatively short shelf life or period of peak bouquet.

By subjecting the juice to ultrasonic energy to produce cavitations at or near the juice's peak bouquet, as in wine, the ultrasonic energy can break down and agglomerate the juice compounds, releasing and combining tartaric acids, malic acids, phenols, polyphenols, sugars, and vaporous gases, for example, that influence flavor. Modification of protein structures can occur, which may significantly benefit taste, aroma, stability, and/or color of the resultant juice. If preservatives are used, the ultrasonic energy may break down those preservatives into gases, which may be agglomerated in the cavitations, thereby minimizing the amount normally used to preserve the product.

FIG. 1 also illustrates a liquid altering device that contains a membrane 110. The membrane 110 can be coupled to the housing 102 and can be situated at least partially within the first chamber 106. The membrane 110 can have an opening 112 that can be sized to allow the liquid-containing vessel to pass through the opening 112 and at least partially into the first chamber 106. In some embodiments, the opening 112 can be flexible, allowing the opening 112 to vary in size as different sized liquid-containing vessels pass through the opening 112, or as different sized portions of the same liquid-containing vessel pass through the opening 112. The opening 112 can have a rim 114, which can contact the liquid-containing vessel as it is removed from the first chamber 106. The rim 114 can act to wipe away at least a portion of liquid on the exterior of the liquid-containing vessel, such as from the liquid coupling medium described above. In some implementations, the membrane 110 may be made from neoprene, nylon, polyethylene, polypropylene, polyvinyl chloride, or the like, by way of example.

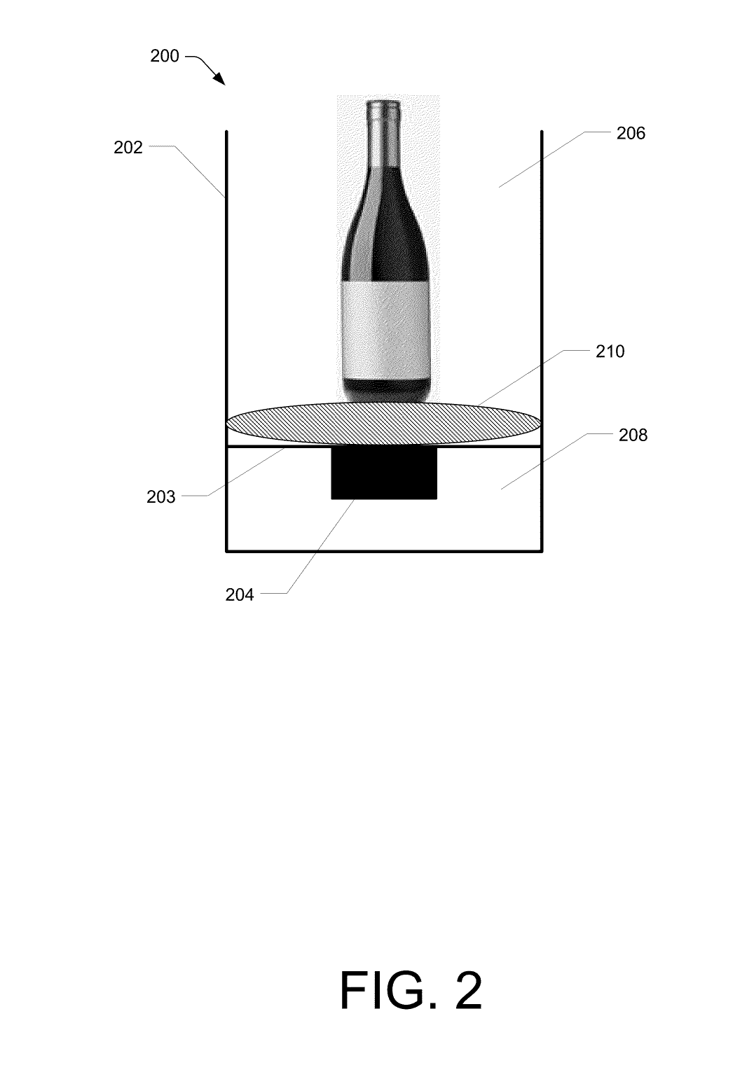

Turning to FIG. 2, a second implementation of the liquid altering device described herein is shown. As in FIG. 1, the device shown in FIG. 2 (200) includes a housing 202, a partition component 203, a first chamber 206, a second chamber 208, and a transducer 204. FIG. 2 depicts a wine bottle received within the first chamber 206. In some implementations, such as that shown in FIG. 2, a bladder 210 can be at least partially situated within the first chamber 206. The bladder 210 can contact at least a portion of the liquid-containing vessel (such as the wine bottle). In some implementations, the bladder 210 may be configured to substantially fill a bottom portion of the first chamber 206 and be disposed along a portion of the partition component 203. In other implementations, the bladder 210 may only partially fill the bottom portion of the first chamber 206 and may only correspond to a size of the bottom of the liquid-containing vessel placed in the device 200.

Ultrasonic energy produced by the transducer 204 can readily be transmitted through the bladder 210, a liquid coupling medium that may surround the liquid-containing vessel, and the liquid-containing vessel itself to cause the cavitations within the liquid as described above. In some implementations, bladder 210 may conform to the bottom profile of the liquid-containing vessel being processed, thus minimizing air or high acoustic impedance barriers between the transducer 204 and the liquid being processed. The device 200 may provide superior transmission of ultrasonic energy while also minimizing heat buildup, which may occur in direct liquid coupling as described in FIG. 1.

In some implementations, the housing 202 may be plastic, metal, or a combination thereof. In some implementations, the bladder 210 may comprise a flexible, thin membrane made of a polymer or similar material configured to hold a liquid. In some instances, the liquid within the bladder 210 may be degassed before being sealed in bladder 210 to avoid cavitations within the bladder 210 when the transducer 204 is in operation. In some implementations, the internal portion of the bladder 210 may also hold a liquid coupling medium as described above with reference to FIG. 1.

While not illustrated in FIG. 2, this implementation (and any other described herein) may include the membrane 110 as shown in FIG. 1 to wipe away the liquid coupling medium from the liquid-containing vessel as it is removed from the first chamber 206 of the housing 202 as described above.

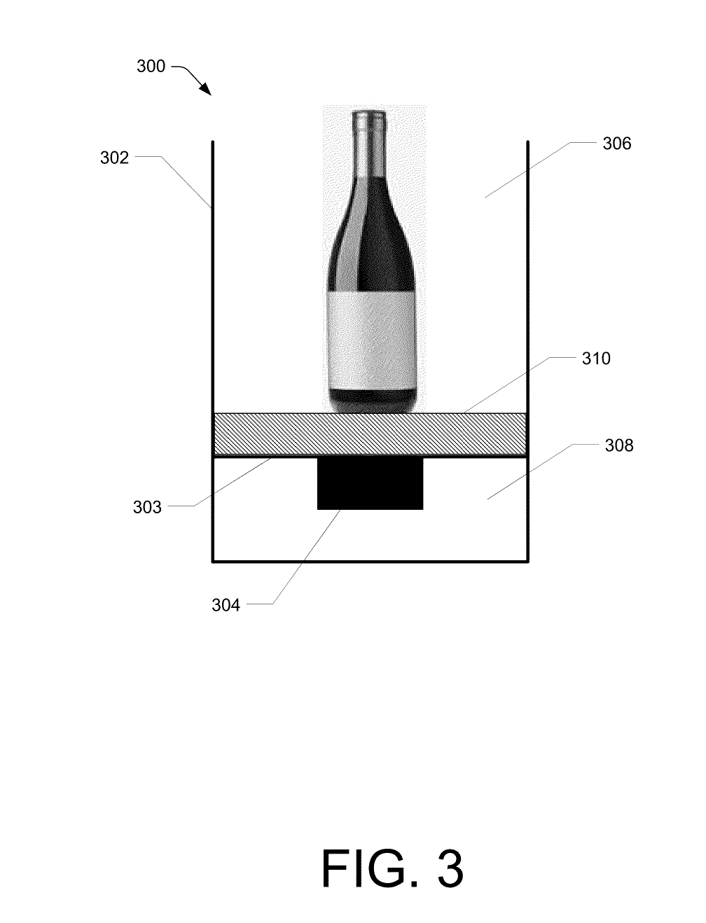

Turning now to FIG. 3, a third implementation of the liquid altering device described herein is shown. As in FIG. 1, the device shown in FIG. 3 (300) includes a housing 302, a partition component 303, a first chamber 306, a second chamber 308, and a transducer 304. In some implementations, the housing 302 may be made of plastic, metal, or a combination thereof. In some implementations, a pad 310 can be situated at least partially within the first chamber 306. For instance, pad 310 may span the entire partition component 303 in the first chamber 306. However, in other instances, the pad 310 may only partially span the partition component 303 such that the size and shape only corresponds to a bottle of liquid placed inside the first chamber 306. The pad 310 can be in contact with a least a portion of the liquid-containing vessel (such as a wine bottle shown in FIG. 3). In some implementations, the pad 310 may be made of a low durometer, low acoustic impedance, and/or low impedance material configured to easily transfer the ultrasonic energy from the transducer 304 to the liquid within the liquid-containing vessel. FIG. 3 may include a liquid coupling medium as described above to further allow the cavitations to form in the liquid within the liquid-containing vessel.

FIG. 3 shows that the liquid may be processed in a bottle such as a typical wine bottle. In some implementations, ultrasonic energy produced by the transducer 304 can readily be transmitted through the pad 310, liquid coupling medium, and the bottle to cause cavitations within the liquid as described above. In some implementations, pad 310 may conform to the bottom profile of the liquid-containing vessel being processed, thus minimizing air or high acoustic impedance barriers between the transducer 304 and the liquid being processed.

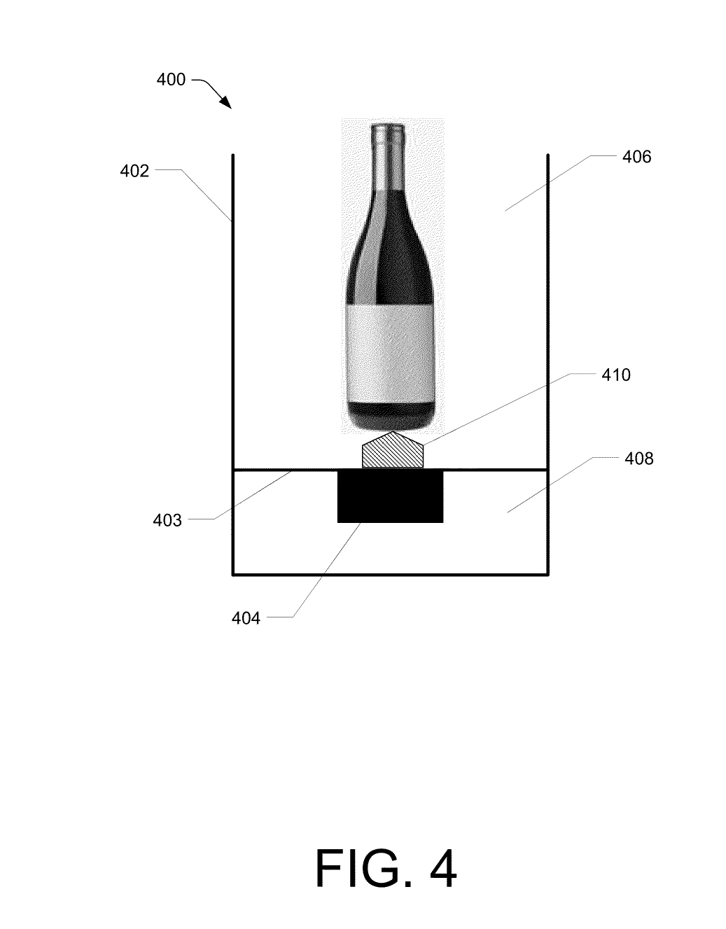

Turning now to FIG. 4, a fourth implementation of the liquid altering device described herein is shown. As in FIG. 1, the device shown in FIG. 4 (400) includes a housing 402, a partition component 403, a first chamber 406, a second chamber 408, and a transducer 404. In some implementations, housing 402 may be made of plastic, metal, or a combination thereof. In some implementations, the first chamber 406 may be configured to hold a liquid coupling medium. In some implementations, the liquid coupling medium may be water. In addition, the first chamber 406 may be configured to hold a standoff coupler 410. In some implementations, the standoff coupler 410 may be made of a low durometer and/or low impedance material configured to easily transfer the ultrasonic energy from the transducer 404 to the liquid within the liquid-containing vessel.

FIG. 4 shows that the liquid may be processed in a bottle such as a typical wine bottle. In some implementations, ultrasonic energy produced by the transducer 404 can readily be transmitted through the standoff coupler 410, liquid coupling medium, and the bottle to cause cavitations within the liquid as described above. In some implementations, standoff coupler 410 may conform to the contours of the bottom profile of the bottle being processed, thus minimizing impedance barriers between the transducer 404 and the liquid being processed.

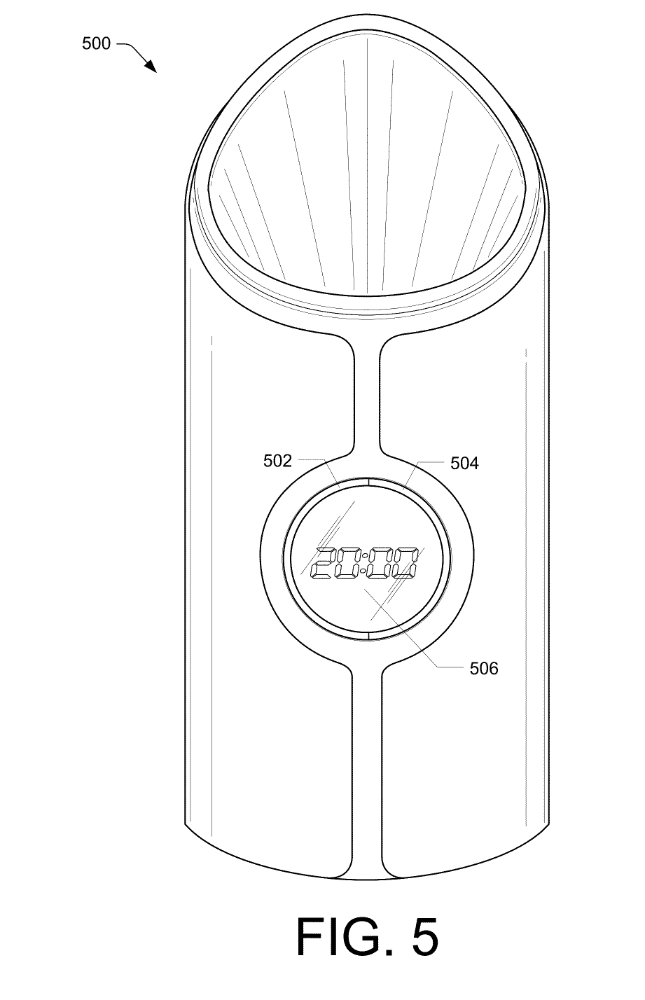

FIG. 5 illustrates an example implementation of a device 500 to alter molecular structures of a liquid. The device 500 may be used in the implementations described above in FIGS. 1-4 with a transducer to provide ultrasonic energy. In some implementations, device 500 may have a first button 502 and a second button 504. The first button 502 may be programmed to direct the transducer to provide a specific ultrasonic frequency, a specific sequence of ultrasonic frequencies, and/or a specific amount of time to provide ultrasonic frequency. The second button 504 may be programmed to direct the transducer to provide a different specific ultrasonic frequency as compared to the frequency directed by the first button 502, a different specific sequence of ultrasonic frequencies as compared to the frequency directed by the first button 502, and/or a different specific amount of time to provide ultrasonic frequency as compared to the frequency directed by the first button 502. In some implementations, the first button 502 may be preconfigured to direct, upon a user pressing the first button 502, the transducer of device 500 to provide ultrasonic energy of a specific frequency, pattern and/or duration toward a bottle of red wine. In contrast, second button 504 may be preconfigured to direct, upon a user pressing the second button 504, the transducer of device 500 to provide ultrasonic energy of a specific frequency, pattern and/or duration toward a bottle of white wine. The time range for each button may be customizable by the user, and may range from 1 to 99 minutes or longer. The buttons may also be preset to any given time, such as, for example, 10 or 20 minutes.

In some implementations, the device 500 may further include a display 506 to display information such as an LCD display. In some instance, the display 506 may display information such as a countdown timer indicating a time remaining in the ultrasonic process, a current frequency being produced by the transducer, or other information.

In some implementations, device 500 may include one or more processors and memory which may store various modules, applications, programs, or other data. The memory may include instructions that, when executed by the one or more processors, cause the processors to perform the operations described herein for operation of device 500.

For instance, the device 500 may be configured with a network interface module coupled to an antenna to support both wired and wireless connection to various networks, such as cellular networks, radio, Wi-Fi networks, short range networks (e.g., Bluetooth), IR, and so forth. For example, the antenna may receive a wireless signal at the wireless unit from an auxiliary electronic device via a dedicated application, the signal comprising data which may be displayed on the display 506. The network interface may provide an ability to send and/or receive information about a particular liquid, along with other products and services related to the liquid, such as recommended food pairings, leisure activities, travel, and other related promotional offers.

The memory may include computer-readable storage media (“CRSM”), which may be any available physical media accessible by the processor to execute instructions stored on the memory. In one basic implementation, CRSM may include random access memory (“RAM”) and Flash memory. In other implementations, CRSM may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or any other medium which can be used to store the desired information and which can be accessed by the processor.

Implementations may be provided as a computer program product including a non-transitory CRSM having stored thereon instructions (in compressed or uncompressed form) that may be used to program a computer (or other electronic device) to perform processes or methods described herein. Further, implementations may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be by an Internet download.

In some implementations, the memory may store a data capture module, a data storage module, and a data providing module (not shown). The modules may be stored together or in a distributed arrangement. In some implementations, the modules may represent services that may be performed using components that are provided in a distributed arrangement, such as by virtual machines running in a cloud computing environment.

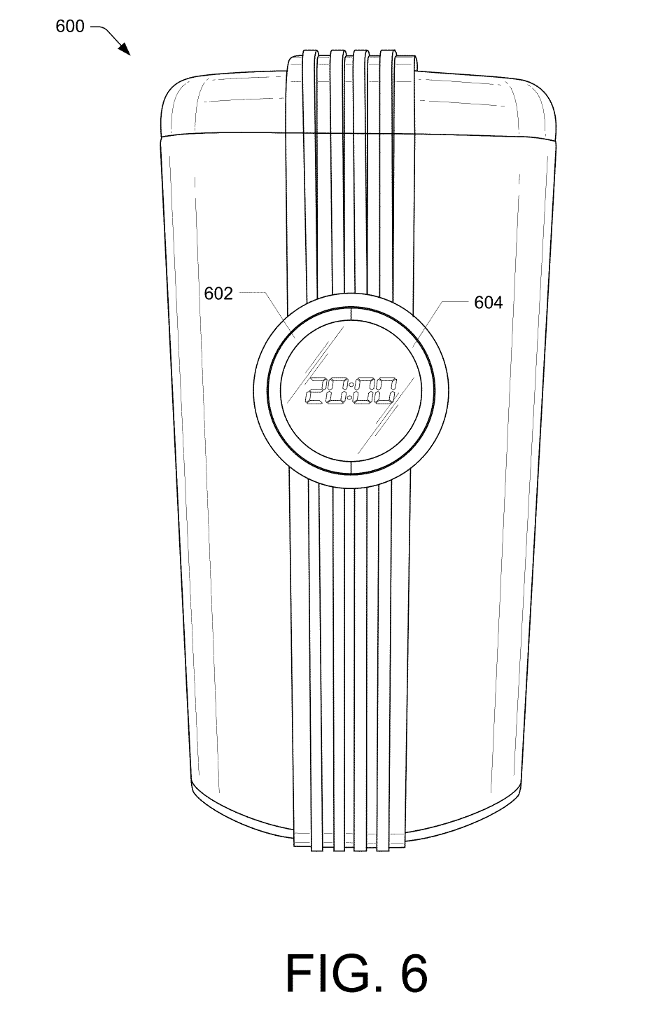

FIG. 6 illustrates an example implementation of a device 600. Device 600 may include similar features as described above with regard to FIG. 5. In some implementations, device 600 may be configured to alter the molecular structure of bottled liquor, spirits and/or fruit juice. For instance, buttons 602 and 604 may be coupled to power circuitry to activate a transducer configured to provide substantially the same ultrasonic frequencies as compared to the device 500 shown in FIG. 5 but at a greater power. For instance, the transducer in device 600 may be configured to provide three time the power as compared to the device 500 but with a consistently similar ultrasonic frequency. In other implementations, the transducer in device 600 may be configured to provide three times the ultrasonic energy as compared to device 500. In some instance, the extra comparative energy or power provided by device 600 may be needed to alter a molecular structure of a liquor or spirit while the greater ultrasonic energy/power may damage the molecular structure of a more delicate liquid such as wine.

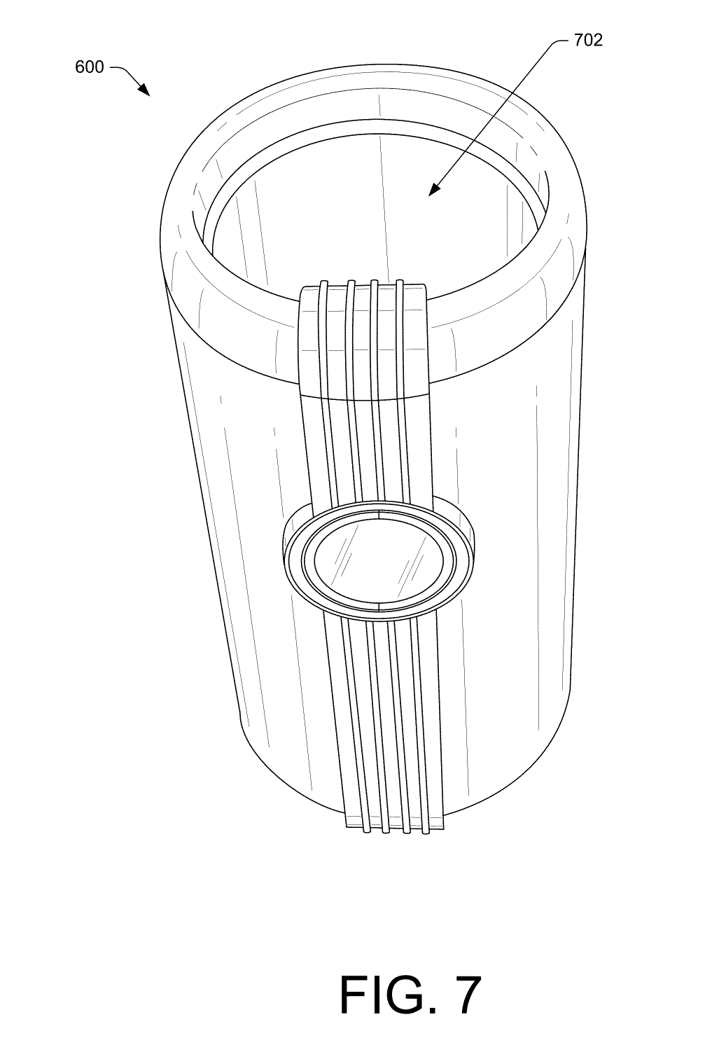

FIG. 7 illustrates a top perspective view of device 600. As described with the implementations above, a liquid coupling medium (e.g., water) may be placed in the opening 702 of device 600. In addition, a bottle of liquid may also be placed in the opening 702. In some implementation, the device 600 may include a top or cover (not illustrated) to wipe the liquid coupling medium from the bottle as it is removed from opening 702.

### Example Large Batch Methods and Systems

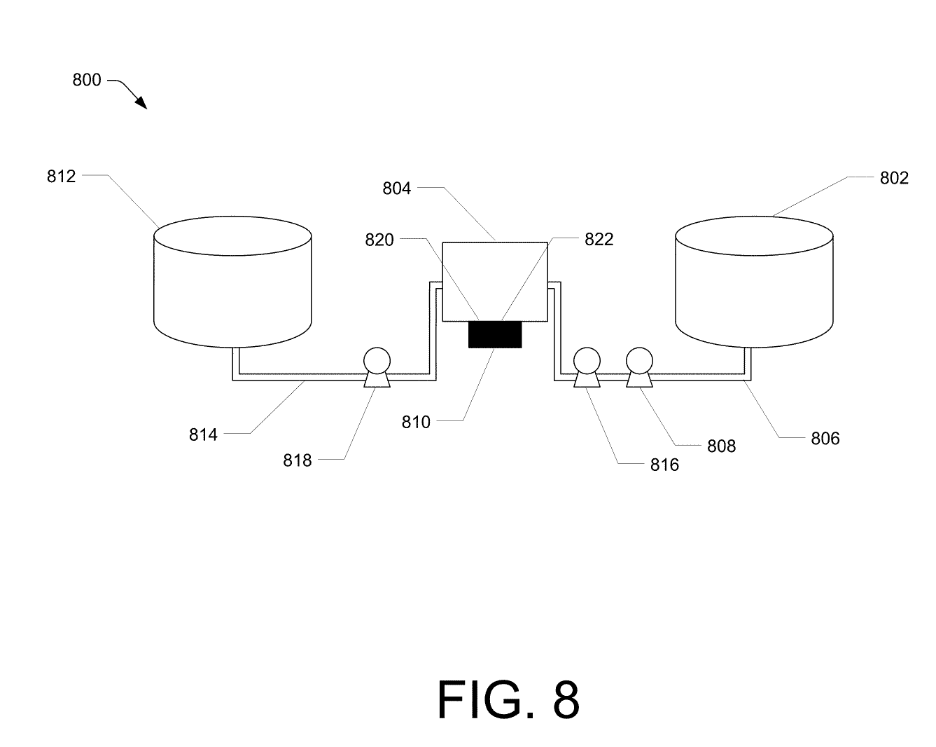

FIGS. 8-11 illustrate example systems to alter molecular structures of compounds of a liquid. Each of the systems of FIGS. 8-11 are intended to alter molecular structures using a continuous flow methodology as described herein.

Typically, in systems that utilize the continuous flow methodology for providing ultrasonic energy to a liquid, a large quantity of liquid may be processed. While the ultrasonic frequency produced by the transducer may or may not be constant, exposure time may be controlled by rate of flow of the liquid and backpressure within the processing container.

In some implementations, a continuous flow system may allow the use of a greater concentration of ultrasonic energy over a shorter exposure time and can be controlled by rate of flow. As an example, at 20 kHz power levels, as much as 2-10 watts per ml can safely be applied to certain wines at flow rates of 20 grams per minute. While this approach may allow a high concentration of ultrasonic energy, erosion of the transducer's surface and metal fatigue may become a minor cost factor. In some implementations, a degassing container or degassing portion of the exposure container may be employed after initial processing of the liquid. The degassing container may minimize or eliminate gases created during processing that could not be removed in the processing chamber. Those gases, if not removed, may be absorbed back into the treated liquid through agitation or otherwise.

As mentioned above, the presence of dissolved or undissolved gases in liquids may be detrimental to taste, preservation, and/or flavor of the liquid. Such gases can be added into the liquid by agitation, pumping, shaking, or even standing within natural or positive pressure atmospheric environments. In wine, for example, when inserting a cork into the bottle holding the wine, positive pressure may be created within the bottle. Some wine makers introduce nitrogen into the bottle for protection of the wine, but the nitrogen may be forced into the wine and, if not released, may affect flavor and/or aroma of the wine and may be absorbed by the human body upon consumption. Therefore, allowing wine to breathe before consumption can be practiced, but even allowing wine to breathe may release only a minimal amount of the nitrogen or other gases within the wine.

Turning now to FIG. 8, a first implementation of a system for altering liquids (800) is illustrated. The components of system 800 can include a first container 802 sized to receive and hold liquid. The first container 802 may include openings, ports, or other means to allow liquid to enter the first container 802 and be maintained within the first container 802 before processing as described herein. System 800 can also include a second container 804 that can be coupled to the first container 802 by a first tube 806. The first tube 806 can be of varying lengths and sizes to accommodate a variety of liquids or system configurations. By way of example, the first container 802 and the second container 804 may be in the same room, or may be situated in different rooms, buildings, or geographic locations. The first tube 806 may be of any length to couple the first container 802 and the second container 804 such that liquid may flow from the first container 802 to the second container 804, or vice versa. In some embodiments, first tube 806 can be absent, and the first container 802 and the second container 804 can be coupled together.

A pump 808 may also make up a component of system 800. In an embodiment, the pump 808 may be coupled to the first tube 806. The pump 808 may promote or otherwise cause flow of liquid from the first container 802 to the second container 804, or vice versa. The pump 808 may operate manually or electronically, and when electronically, may operate within a computing environment and/or wirelessly. The pump 808 may control the speed of the liquid traveling through system 800 during processing as described above. In some embodiments, the pump 808 may be disposed anywhere in system 800.

One or more transducers 810 may also make up a component of system 800. In an embodiment, the transducer 810 may be placed in acoustic communication with the second container 804. Acoustic communication can include being placed in proximity to the second container 804 such that when the transducer 810 is operative, the ultrasonic energy transmitted from the transducer 810 may travel at least partially into the second container 804 and is capable of interacting with liquid within the second container 804. The transducer 810 may be capable of producing an ultrasonic frequency that may be directed into liquid within the second container 804.

A third container 812 may also make up a component of system 800. In an embodiment, the third container 812 can be coupled to the second container 804 by a second tube 814. The second tube 814 can be of varying lengths and sizes to accommodate a variety of liquids or system configurations. By way of example, the second container 804 and the third container 812 may be in the same room, or may be situated in different rooms, buildings, or geographic locations. The second tube 814 may be of any length to couple the second container 804 and the third container 812 such that liquid may flow from the second container 804 to the third container 812, or vice versa. It is to be understood that while the example embodiment in FIG. 8 shows the first tube 806 and the second tube 814 as separate tubes, this disclosure includes embodiments wherein the first tube 806 and the second tube 814 are partially or completely the same tube. The first tube 806 and the second tube 814 can be made of a polymer, food-grade plastics, metal, a combination thereof, or other material suitable for allowing liquid to flow within the tubing. In some implementations, the first tube 806 and the second tube 814 may include, for example, 1.5 inch beverage transfer tubing. The third container 812 may act as a storage or transfer container for the processed liquid. In some embodiments, the second tube 814 can be absent, and the second container 804 and the third container 812 can be coupled together.

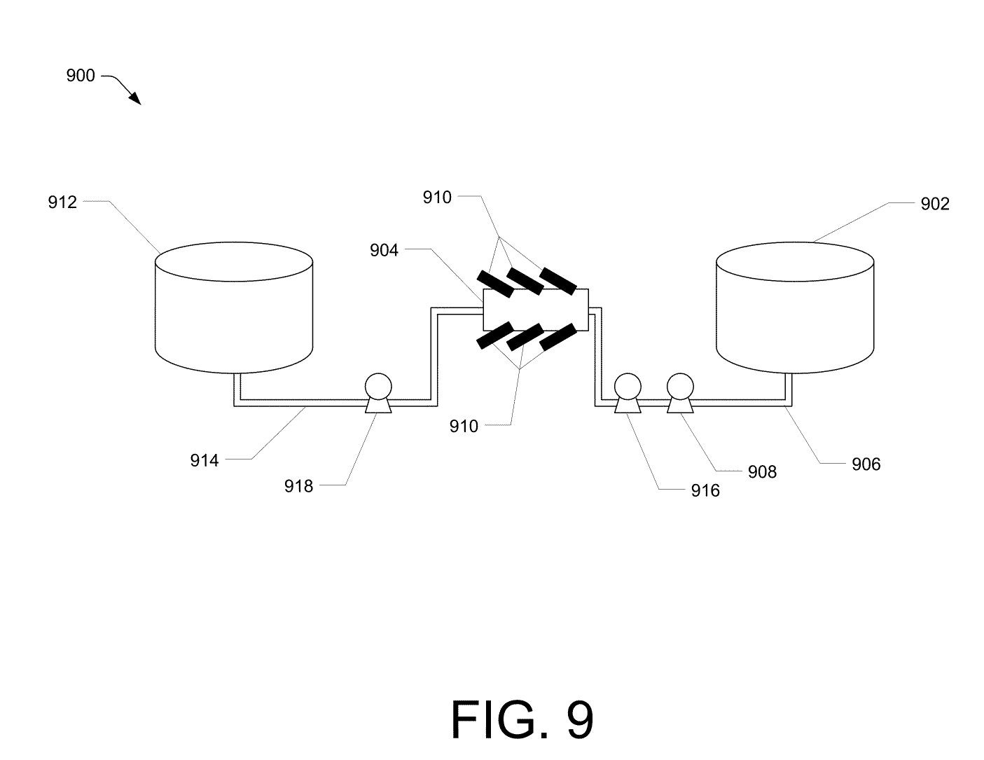

In some implementations, providing a mirror finish 820 to a radiating surface 822 of the transducer 810 can minimize erosion (as shown in FIG. 9). The radiating surface 822 of the transducer 810 can define the portion of the transducer 810 that expels the ultrasonic energy from the transducer 810.

A pressure gauge 816 may also make up a component of system 800. In an embodiment, the pressure gauge 816 can be coupled to the first tube 806, the second tube 814, or to any other component of system 800. The pressure gauge 816 can measure the pressure within system 800, which can provide an operator or a computing environment with pressure-related information to be used to control and adjust the cavitation formation within system 800, as described above.

A flow valve 818 can also make up a component of system 800. In an embodiment, the flow valve 818 can be coupled to the first tube 806, the second tube 814, or to any other component of system 800. The flow valve 818 can allow a user or a computing environment to adjust pressure within system 800 or the components thereof by, for example, allowing more or less liquid to flow from the second container 804 to the third container 812. In some instances, an appropriate amount of backpressure may enhance results.

The positioning of the transducer 810 can vary. In some implementations, the transducer 810 may be positioned such that the radiating surface 822 of the transducer 810 faces the direction of flow of the liquid. The transducer 810 may be configured to produce ultrasonic energy on an exponential or stepped basis for purposes of creating maximum excursion and energy at the radiating surface 822. The transducer 810 may also be placed at some angle, for example a 90° angle from the direction of flow of the liquid. If placed at a 90° angle from the direction of flow, the ultrasonic energy may be bent or otherwise altered as liquid flows, which could attenuate the effectiveness of the cavitations. It should be understood that the present disclosure includes embodiments wherein the first container 802, second container 804, and third container 812 may be coupled to each other, directly or indirectly, and may make up the same or partially the same container.

Turning to FIG. 9, a second implementation of a system for altering liquids (900) is illustrated. The components of system 900 can be similar to those in FIG. 8 and can include a first container 902, a second container 904, a third container 912, a first tube 906, a second tube 914, at least one transducer 910, a pump 908, a pressure gauge 916, and a flow valve 918. System 900 can allow the methodologies described herein to be practiced. For example, upon leaving the first container 902, the liquid may enter the first tube 906 toward pump 908. As described above, pump 908 may control the flow of the liquid during the continuous flow methodology. In some implementations, the pump 908 may force the liquid through the first tube 906 at from about 5 gallons per minute to about 25 gallons per minute, or more, or from about 6 gallons per minute to about 20 gallons per minute.

FIG. 9 shows a second container 904 including an array of multiple transducers 910 mounted longitudinally on both sides of the second container 904. In some implementations, each transducer 910 of the array may be at an angle such that as liquid flows from the first tube 906 through the second container 904 and into the second tube 914 the ultrasonic energy produced by the transducer 910 may be directed in a direction deviated from the directional flow of the liquid. By way of example, the array of transducers 910 can be positioned such that the ultrasonic energy produced by the transducers 910 are at approximately a 45° angle from the directional flow of the liquid. The focused ultrasonic energy can converge within the second container 904, which can create an intensified ultrasonic energy field. In some implementations, the angle of each transducer 910 may be such that the focal point of the ultrasonic energy is as close to an anti-node or multiples thereof, which can maximize focused energy. The second container 904 may be as long and with as many transducers 910 as the application requires or desires. An advantage of system 900 is that less power may be delivered to each transducer 910, but above the threshold power needed to create cavitations. System 900 shown in FIG. 9 may minimize erosion at the transducer 910 face. Furthermore, focusing ultrasonic energy in a particular direction can achieve a high concentration of cavitations and offset the effect of wave bending due to the forced flow of the liquid.

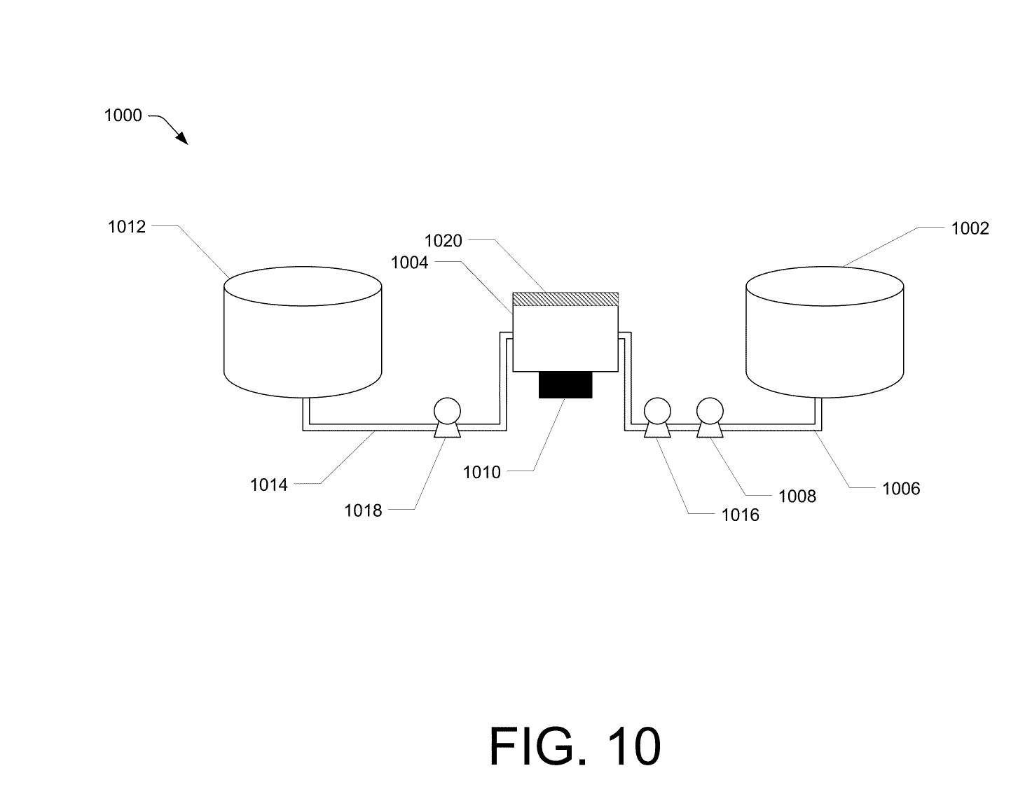

Turing now to FIG. 10, a third implementation of a system for altering liquids (1000) is illustrated. The components of system 1000 can be similar to those in FIG. 8 and can include a first container 1002, a second container 1004, a third container 1012, a first tube 1006, a second tube 1014, at least one transducer 1010, a pump 1008, a pressure gauge 1016, and a flow valve 1018. System 1000 may also include a degassing opening 1020, which can be considered a degassing mechanism, wherein the degassing opening 1020 may be disposed in the second container 1004 and may be positioned to allow gas from within the second container 1004 to exit the second container 1004 without allowing liquid from within the second container 1004 to exit the second container 1004. In some instances, the continuous flow methodology described herein, while efficient in changing molecular structure and agglomerating gases, may not allow degassing to occur in all instances, and if left in such a condition, gases may be absorbed back into the liquid and may negatively affect taste and the beneficial effects of exposure to ultrasonic energy. In some instances, as illustrated in FIG. 10, this can be overcome by employing the degassing opening 1020 to expel gases released from the liquid as a result of the cavitations caused by the ultrasonic energy.

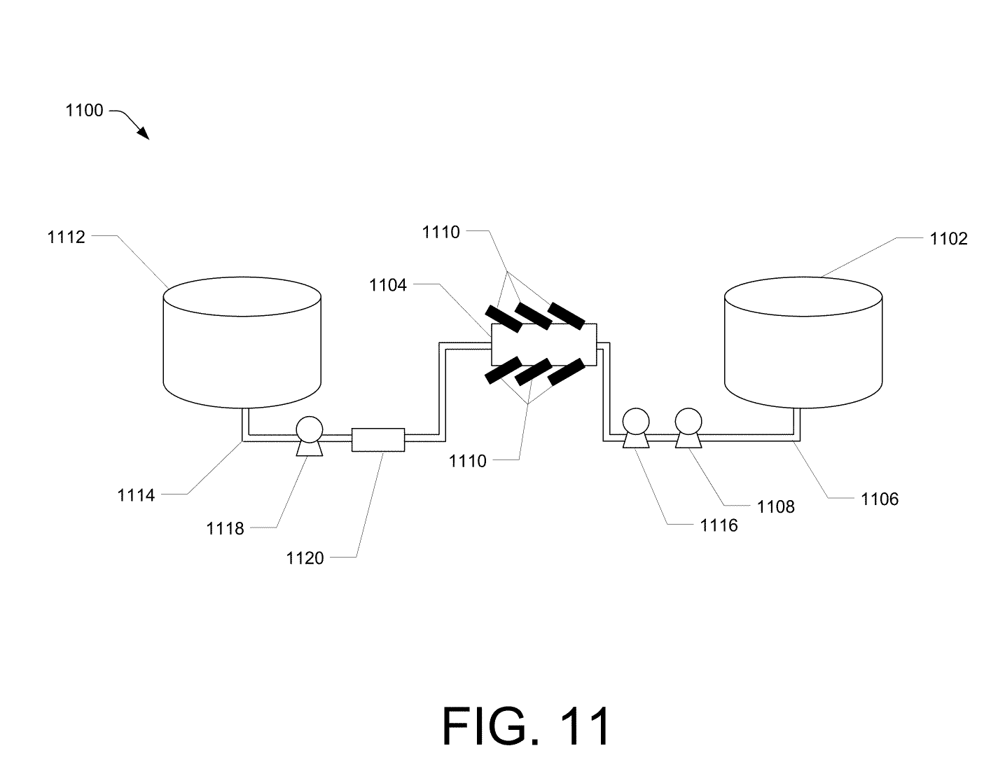

Turning now to FIG. 11, a fourth implementation of a system for altering liquids (1100) is illustrated. The components of system 1100 can be similar to those in FIG. 9 and can include a first container 1102, a second container 1104, a third container 1112, a first tube 1106, a second tube 1114, at least one transducer 1110, a pump 1108, a pressure gauge 1116, and a flow valve 1118. System 1100 may also include a fourth container 1120 coupled to the second tube 1114 or a third tube (no shown). An opening in the fourth container 1120 can be positioned to allow gas from within the fourth container 1120 to exit the fourth container 1120 without allowing liquid from within the fourth container 1120 to exit the fourth container 1120. In some implementations, these features of system 1100 may perform identically or similar to the features described above with reference to FIGS. 8-10.

FIG. 11 shows system 1100 may include the fourth container 1120 positioned between the second container 1104 and the flow valve 1118. In some implementations, as shown in FIG. 11, the fourth container 1120 may be a degassing container as described above. In other implementations, the fourth container 1120 may be used to introduce flavors, spices, fortifications or other additives to the liquid. The additives can be capable of introducing scent, taste, or visual characteristics to the liquid. For instance, the fourth container 1120 may include wood chips, which may add a specific flavor characteristic to a consumable liquid. In some implementations, the fourth container 1120 may act as a degassing container and an additive container. Furthermore, the fourth container 1120, when used as an additive container, may be placed prior to the second container 1104 of system 1100.

In some implementations, systems 800, 900, 1000, and/or 1100 may include a temperature regulator such as a heating coil or cooling coil. The temperature regulator may alter the temperature of the liquid within the system and/or alter the viscosity of the liquid. In some instance, these alterations may enhance the effectiveness of the cavitations produced by the transducers as described above.

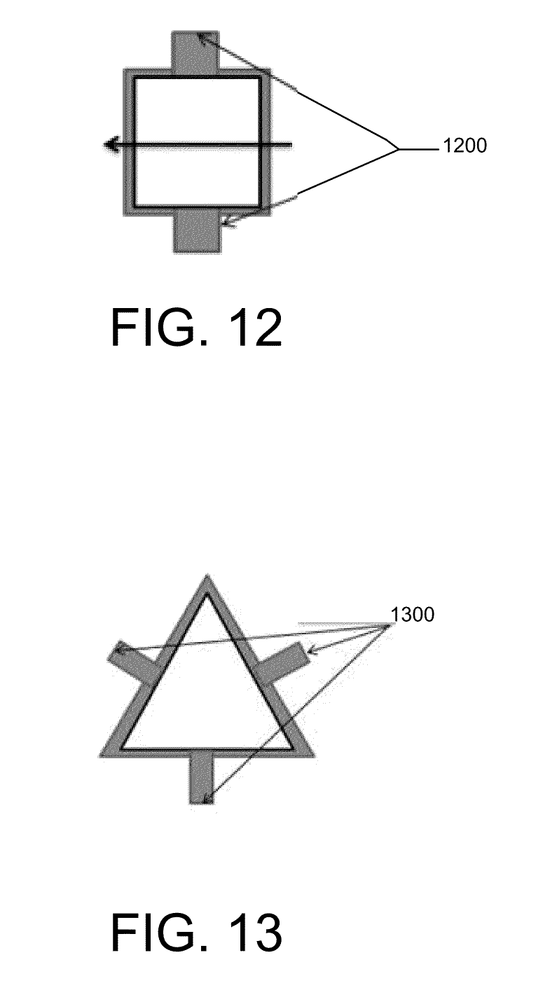

FIG. 12 illustrates a cross-sectional view of an example exposure container that may be used in conjunction with the environments described above in FIGS. 8-11. FIG. 12 shows transducers 1200 mounted directly opposite from each other on the exposure container. In such a system, dimensions of the flow of the liquid through the exposure container should be considered to avoid cancellation of the ultrasonic energy produced by each transducer 1200.

FIG. 13 illustrates a cross-sectional view of an example triangular exposure container that may be used in conjunction with the environments described above in FIGS. 8-11. FIG. 13 shows a triangular array of multiple transducers 1300 on each wall of the exposure container. In some implementations, the array shown may create a concentrated ultrasonic energy field and provide equal coverage within the exposure container.

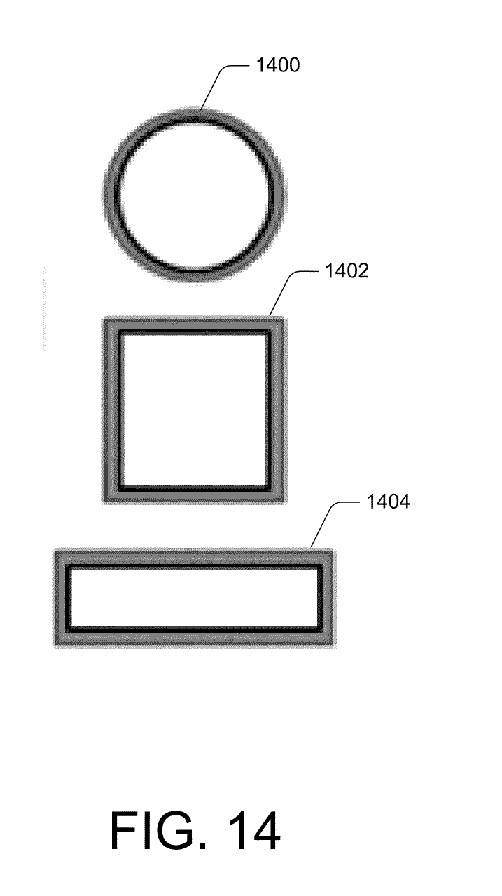

FIG. 14 illustrates an example cross-sectional view of various example shapes of the exposure container that may be used in conjunction with the environments described above in FIGS. 8-11. In some implementations, the exposure container may be a circular container 1400 (including a cylindrical embodiment), a square container 1402, a rectangular chamber 1404 (including a cube embodiment), or some other shape capable of holding liquid. Any of the shapes may be used to form a suitable exposure container. For instance, a rhombus container, an oval container, triangular container, etc. can be used.

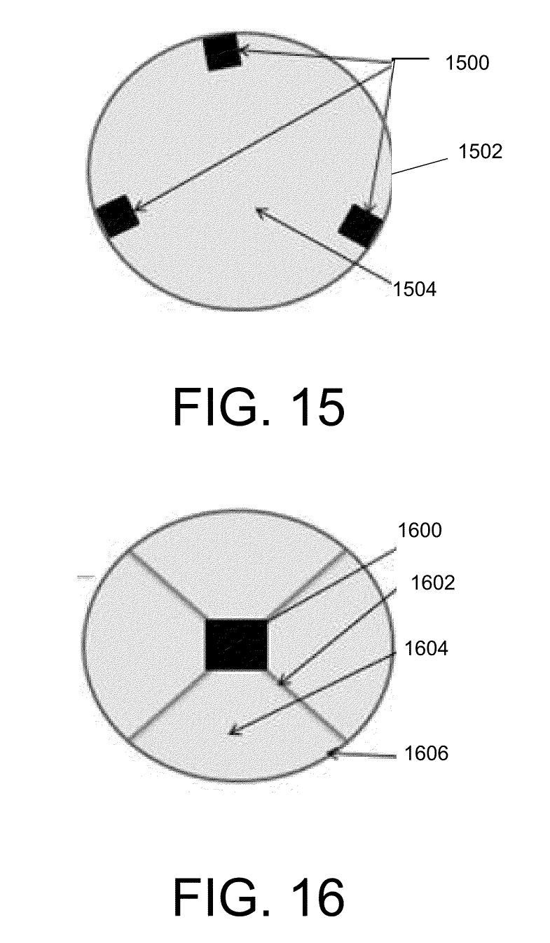

FIG. 15 illustrates a cross-sectional view of an example exposure container that may be used in conjunction with the environments described above in FIGS. 8-11. FIG. 15 shows an array of multiple transducers 1500 on each wall of the exposure container 1502. In some implementations, the array shown may create a concentrated ultrasonic energy field and provide equal coverage within the exposure container.

FIG. 16 illustrates a cross-sectional view of an example exposure container that may be used in conjunction with the environments described above in FIGS. 8-11. FIG. 16 shows one or more transducers 1600 hanging in the exposure container 1606, for energy coverage radiating from the transducers 1600 into the liquid 1604, providing energy reinforcement and minimum cancellation. The transducers 1600 can be suspended within the liquid with connection lines 1602.

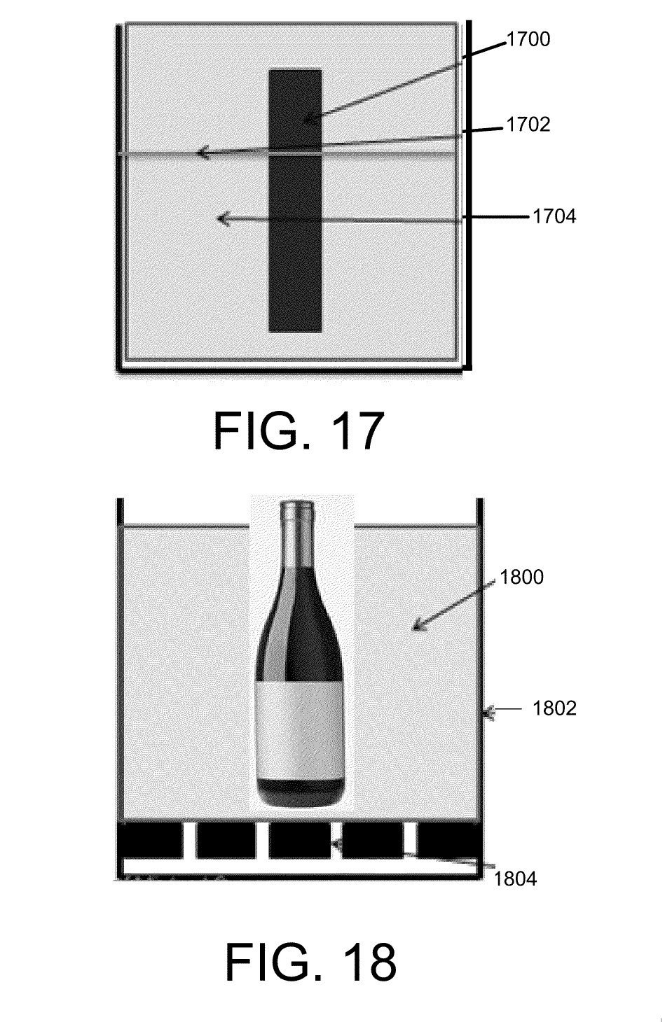

FIG. 17 illustrates a cross-sectional view of an example exposure container that may be used in conjunction with the environments described above in FIGS. 8-11. FIG. 17 shows an array of stacked transducers 1700 hanging or otherwise suspended in the exposure container 1704, for energy coverage radiating from the transducers 1700 into the liquid, providing energy reinforcement and minimum cancellation. Line 1702 illustrates the liquid level in the exposure chamber 1704.

FIG. 18 illustrates a cross-sectional view of an example exposure container that may be used in conjunction with the environments described above in FIGS. 1-4. FIG. 18 shows an exposure container 1802 with multiple transducers 1804 mounted on one side of the exposure container and propagating ultrasonic energy through a liquid media into a container such as a 750 ml or 1.5 liter bottle. Energy can readily be transmitted in this manner due to the low acoustic impedance of glass or similar containers having a low acoustic impedance.

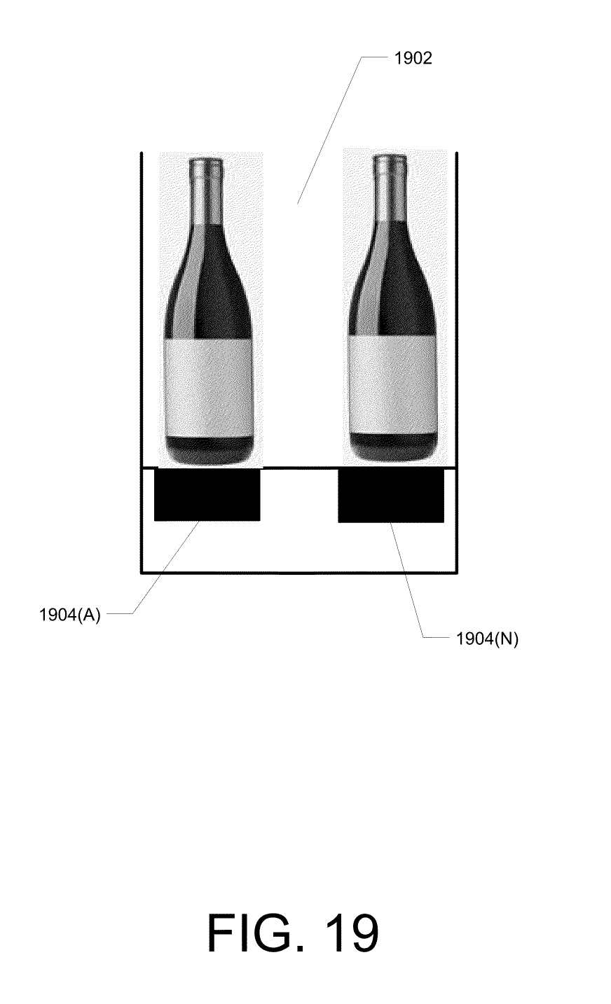

It should also be understood that the present disclosure is not limited to methods and devices that process only one vessel of liquid at a given time. To the contrary, the present disclosure includes methods and devices for processing multiple vessels of liquid at a given time. As shown in FIG. 19, two bottles, four bottles, six bottles, eight bottle, or ten bottles of wine, by way of example, could be processed at the same time within a first chamber 1902. FIG. 19 shows each of the two bottles of wine being processed by transducers 1904(A)-(N). However, the multiple bottles could be processed with fewer transducers 1904(A)-(N) than bottles or more transducers 1904(A)-(N) than bottles. In some implementations, the transducers 1904 may be individually controllable from the other transducers 1904 such that, for example, transducer 1904(A) may be activated while transducer 1904(N) may be deactivated. Furthermore, each transducer 1904 may be preset with a designated frequency. In some implementations, the transducers 1904 may work together to sweep or cycle between designated frequencies to control the overall ultrasonic action within the first chamber 1902.

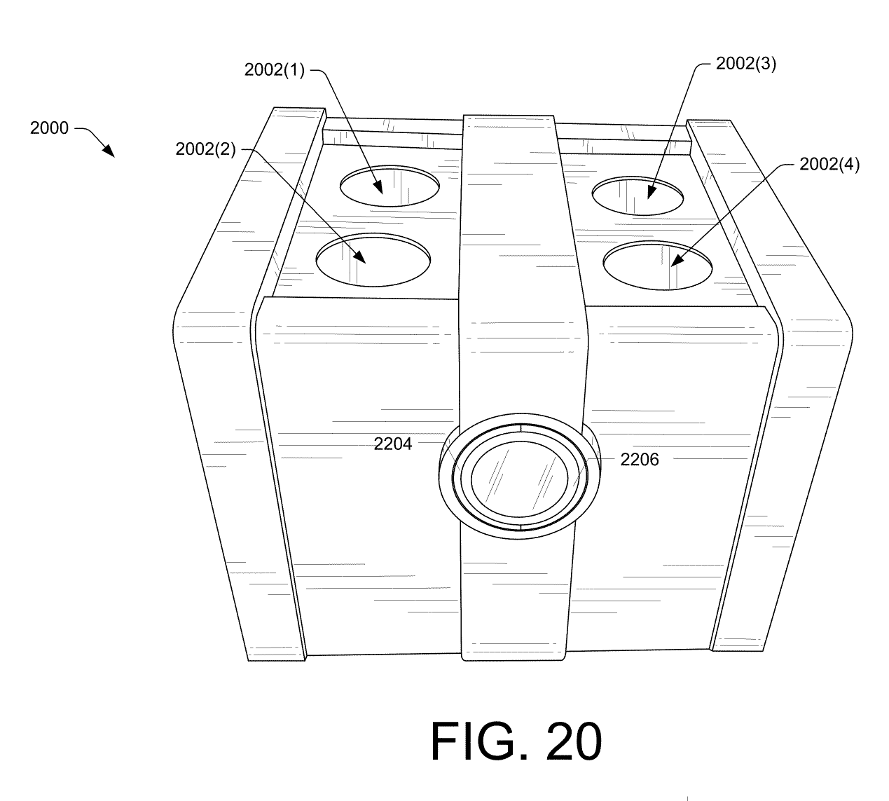

FIG. 20 illustrates an example device 2000 to alter molecular structures in multiple bottles of liquids. Similar to the implementation described above with regard to FIG. 19 and devices 500 and 600 described in FIGS. 5 and 6, respectively, device 2000 may be configured to hold a bottle of a liquid in order to alter the molecular structure of the liquid within the bottle. In this implementation, device 2000 is shown it hold as many as four separate bottles of liquid. In other implementations, device 2000 may be configured to hold fewer bottles (e.g., two or three) or more bottles (five, six, seven, eight, nine, ten, etc).

While not illustrated in FIG. 20, device 2000 may include multiple transducers positioned at the base of each opening 2002(1)-(4). In other implementations, fewer or more transducers than bottle placement openings may be located in device 2000. Furthermore, each of the multiple transducers may be configured to provide the same ultrasonic frequency or a different ultrasonic frequency. In some implementations, buttons 2204 and 2206 may be coupled to electronic circuitry configured to activate all or a subset of the multiple transducers in device 2000. For instance, a user depressing button 2204 may provide a signal to activate the transducers associated with openings 2002(1) and 2002(2). However, in other implementations, a single button may be located on the device 2000 to simultaneously activate each of the multiple transducers.

It should be further understood that the present disclosure is not limited to methods, devices, and systems that process liquid via only ultrasonic energy. Any frequency or wavelength of energy is specifically included in this disclosure and is not limited to only ultrasonic energy.

It should be further understood that the present disclosure includes both consumable and non-consumable liquids. Certain examples of consumable liquids have been provided herein, but this disclosure is not limited to those examples.

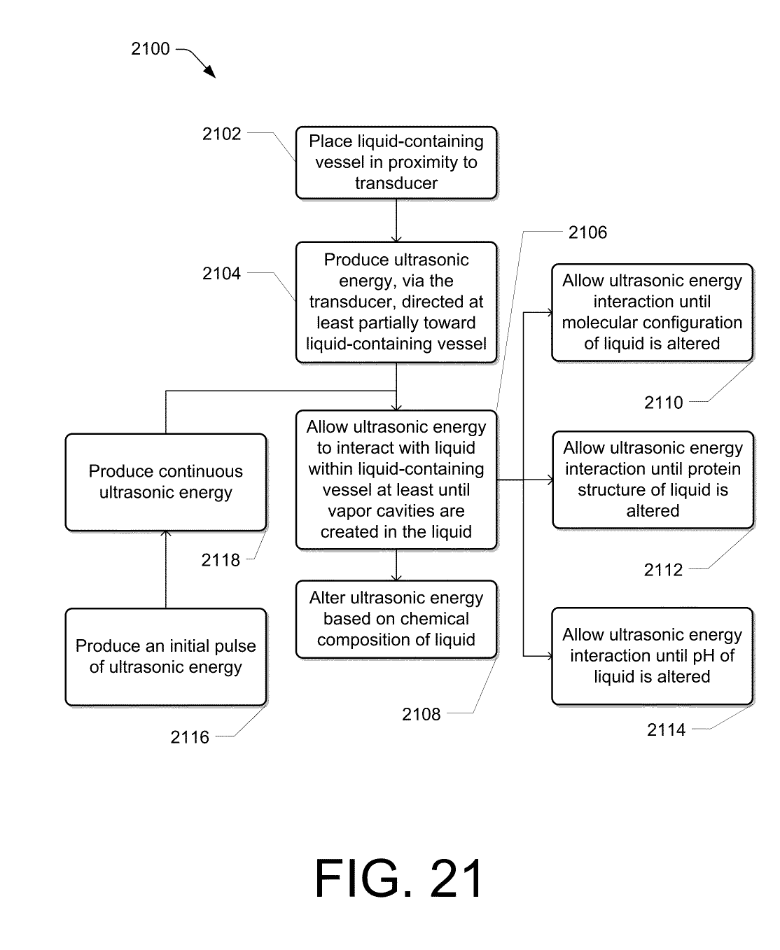

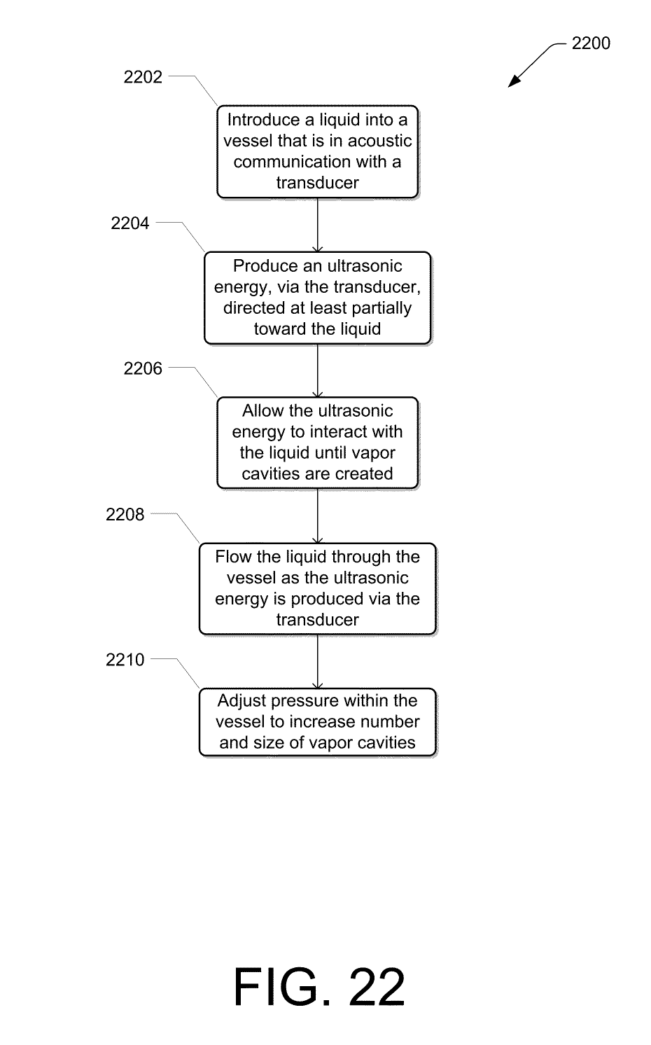

FIGS. 21 and 22 illustrate example processes 2100 and 2200, respectively, for altering molecular structures of a liquid. The processes 2100 and 2200 are illustrated as logical flow graphs. The order in which the operations or steps are described is not intended to be construed as a limitation, and any number of the described operations can be combined in any order and/or in parallel to implement the processes 2100 or 2200.

Turning to FIG. 21, a method of altering liquid (2100) is shown. At block 2102, the method can include placing a liquid-containing vessel in proximity to a transducer. Block 2104 describes producing ultrasonic energy, via the transducer, directed at least partially toward the liquid-containing vessel. Block 2106 describes allowing ultrasonic energy to interact with liquid within the liquid-containing vessel at least until vapor cavities are created in the liquid. This method can be performed using the devices described herein. Additionally, method 2100 may include, at block 2108, altering the ultrasonic energy based on the chemical composition of the liquid in the liquid-containing vessel. Method 2100 may also include allowing the ultrasonic energy to interact with the liquid until the molecular configuration of the liquid is altered (block 2110), until the protein structure of the liquid is altered (block 2112), and/or until the pH of the liquid is altered (block 2114). Furthermore, method 2100 may include, at blocks 2116 and 2118, producing an initial pulse or burst of ultrasonic energy and then producing a continuous stream of ultrasonic energy, as described more fully above.

Turning to FIG. 22, a method of altering liquid (2200) is shown. At block 2202, the method can include introducing a liquid into a vessel that is in acoustic communication with a transducer. Block 2204 describes producing ultrasonic energy, via the transducer, directed at least partially toward the liquid. Block 2206 describes allowing the ultrasonic energy to interact with the liquid until vapor cavities are created. This method can be performed using the systems described herein. Additionally, method 2200 can include, at block 2208, flowing the liquid through the vessel as the ultrasonic energy is produced via the transducer. Furthermore, method 2200 can include, at block 2210, adjusting pressure within the vessel to increase the number and size of vapor cavities within the liquid.

### EXAMPLES

In the application of processing distilled spirits such as whiskies, cognac, and the full range of distilled alcoholic beverages, there may be fewer compounds to consider since many compounds have been removed in the distillation process of these spirits. After distillation, certain compounds that effect flavor can be added back into the liquid. At this stage, with flavoring added, the application of ultrasonic energy to generate cavitations can be applied to alter molecular structure, lower pH, enhance flavor, and reduce aging time.

Ultrasonic energy may be applied to distilled spirits immediately after distillation or within a few weeks after exposure to elements extracted from oak, thereby reducing the time necessary for aging. In such applications aging can be drastically reduced form years to minutes of exposure. If oak chips or other adjuncts are used rather than barrels, the introduction of ultrasonic energy to generate cavitations may further shorten this process.

Barrel aging can be a long-term process because of the time needed to dissolve the desirable flavors in oak barrels and then only to a certain depth, such as 6 to 8 mm of the barrel. Different oaks largely determine aging time and flavor. Surface area of barrels also affects aging time. Wood chips may provide greater surface area and more thorough penetration of the liquid. Because wood may attenuate sound, it can be necessary to increase the amount of ultrasonic energy using the methodologies described herein to achieve results.

In addition to distilled spirits, many plant extractions (liquids) offered for consumption contain additives that serve only to increase shelf life. Other additives may be added for flavor, but do not necessarily add nutritional value. Some consumers of these plant extractions can experience adverse reactions caused by these additives.

While the described methods, devices, and systems reduce, but may not eliminate additives, the additives may be rendered more effective by breaking down, agglomerating, liquefying, and rendering them in more intimate contact with the compounds they are intended to preserve.

Among the most common and effective of additives used to inhibit extraneous bacteria growth in wines is sulfite. Some countries and states require that sulfite be identified on the label of a bottle containing sulfite. Sulfite's effectiveness in inhibiting extraneous bacteria growth is largely dependent on the amount used. Large-scale wine producers, whose risks are high, may use a higher concentration of additives to avoid spoilage (a financial risk/benefit decision). The down side is the effect on the quality of the wine or end product. Some wine producers make and advertise that they do not use any added sulfite.

Sulfite does not improve taste, nor is it tasteless by itself. Many consumers complain of headaches attributed to sulfite and other additives. Although this has yet to be clinically isolated, there is a significant portion of the population that experiences this effect. Wines not containing sulfite additives usually garnish a higher retail price.

Adverse reaction to sulfite and other preservatives can be attributed to their presence in the form of microscopic vaporous gases throughout the liquid. If left in that state and consumed, those gases can enter the blood stream and be transported to the brain. This may cause headache (“hangover”), or perhaps other even more potentially serious physical effects. Some people are more sensitive than others and refuse to consume wine containing those additives.

The present disclosure embodies a means of permanently and effectively removing those undissolved and/or entrapped gases within the liquid without adversely affecting the preservative aspect to which they were applied or intended, breaking down, agglomerating, and altering molecular structures and releasing entrapped flavors. Equally important is the effect on protein structure and distribution that contribute to sensory improvement.

In some instances, re-processing a bottle of initially processed liquid after a period of time (e.g., 3 days, 5 days, 7 days, for example) may reinvigorate the liquid. This is helpful in a restaurant setting where a bottle of wine may be opened and corked for several days after an initial ultrasonic treatment. In these instances, an additional ultrasonic treatment may break down or allow oxygenated molecules to escape the opened bottle of wine to make the opened bottle of wine taste and/or smell better.

Cavitation bubble size may be defined by frequency. For purposes of removing gases, the operating frequency may not necessarily be sensitive. For purposes of agglomeration and determining molecular structure of the end product, frequency and energy level can become an important consideration.

As an example of proven effectiveness of the present disclosure, we employed the use of a Sulfite Testing Kit “Titrates for the Determination of Sulfite in Wine,” manufactured by CHEMetrics, Inc., Component Catalog NO: A-9610T.

Using a sample 5 gallon batch of a low cost commercially sold wine, achieving a base line indication of sulfite content, and then subjecting it to ultrasonic energy for 15 minutes, at frequencies within 3 kHz from nominal frequency of 40 kHz, we achieved a reading indicating a 39% reduction of sulfite content. There was also a noticeable improvement in the smoothness and taste of the wine attributed to the removal of entrapped gases, agglomeration, and overall change of molecular structure.

While this experiment was with wine, it should not be isolated thereto. This experiment is analogous to any liquid that contains additives such as sulfite that produce unwanted microscopic entrapped gases.

Much of the above addresses the effect of preservatives in wine and beverages that contain preservative additives. Many beverages do not contain added preservatives, yet the effect of subjecting those beverages to ultrasonic energy will yield a far superior tasting product. Olive oil, as an example, does not contain sulfite additives, but by subjecting this product to the methodologies described herein a marked improvement in flavor was noted. This was accompanied by a noticeable reduction in peroxide reading such that the sample tested, originally classified as category “Virgin,” was deemed to be equal to “Extra Virgin” after 20 minutes exposure in a batch processing system, operating at a nominal sweep frequency of 40 kHz.

### CONCLUSION

Although the disclosure describes embodiments having specific structural features and/or methodological acts, it is to be understood that the claims are not necessarily limited to the specific features or acts described. Rather, the specific features and acts are merely illustrative of some embodiments that fall within the scope of the claims of the disclosure.

What is claimed is:

1. A method of altering liquids comprising:
placing a liquid-containing vessel in proximity to a transducer, the transducer in acoustic communication with the liquid-containing vessel;
producing an ultrasonic energy, via the transducer, directed at least partially toward the liquid-containing vessel; and
allowing the ultrasonic energy to interact with liquid within the liquid-containing vessel at least until vapor cavities are created in the liquid.

2. The method of claim 1, wherein the liquid comprises wine, fortified wine, liquor, liqueur, juice, coffee, tea, oil, vinegar, honey, molasses, herb extracts, dairy products, or a combination thereof.

3. The method of claim 1, wherein the ultrasonic energy interacts with esters, tannins, pseudo tannins, polycyclic aromatic hydrocarbons, sulfites, sulfur dioxide, dissolved gases, undissolved gases, tartaric acid, malic acid, phenols, polyphenols, sugars, anthocyanins, flavonoids, enzymes, preservatives, or a combination thereof in the liquid.

4. The method of claim 1, wherein the transducer operates at or between 500 watts to 1,500 watts to produce the ultrasonic energy.

5. The method of claim 1, further comprising:
altering the ultrasonic energy based on chemical composition of the liquid; and
increasing a number and a volume of vapor cavities within the liquid.

6. The method of claim 1, further comprising:
allowing the ultrasonic energy to interact with the liquid within the liquid-containing vessel at least until molecular configuration of the liquid is altered by the ultrasonic energy.

7. The method of claim 1, further comprising:
allowing the ultrasonic energy to interact with liquid within the liquid-containing vessel at least until protein structures of the liquid are altered by the ultrasonic energy.

8. The method of claim 1, further comprising:
allowing the ultrasonic energy to interact with liquid within the liquid-containing vessel at least until the pH of the liquid is altered by the ultrasonic energy.

9. The method of claim 1, further comprising:
producing, via the transducer, an initial pulse of ultrasonic energy; and
producing a subsequent continuous ultrasonic energy.

10. A liquid altering device comprising:
a housing defining an at least partially hollow chamber, the chamber sized to receive a liquid-containing vessel; and
a transducer capable of producing an ultrasonic energy disposed at least partially within the chamber and in acoustic communication with the liquid-containing vessel when received within the chamber.

11. The device of claim 10, further comprising:
a partition component, which divides the chamber into a first section and a second section, the first section sized to receive the liquid-containing vessel and the second section sized to hold the transducer.

12. The device of claim 10, wherein the ultrasonic energy is produced at or between a frequency of 10 kHz and 120 kHz.

13. The device of claim 10, wherein the transducer is programmed to produce differing ultrasonic energy based on characteristics of liquid within the liquid-containing vessel.

14. The device of claim 10, further comprising:
a membrane coupled to the housing and situated at least partially within the chamber;
an opening in the membrane sized to allow the liquid-containing vessel to pass through the opening and at least partially into the chamber; and
a rim of the opening, the rim in contact with the liquid-containing vessel to wipe away at least a portion of liquid on the exterior of the liquid-containing vessel.

15. The device of claim 10, further comprising:
a bladder at least partially within the chamber, the bladder in contact with at least a portion of the liquid-containing vessel when the liquid-containing vessel is received within the chamber, wherein the bladder contains a low impedance liquid medium.

16. The device of claim 10, further comprising:
a pad at least partially within the chamber, the pad in contact with at least a portion of the liquid-containing vessel when the liquid-containing vessel is received within the chamber, wherein the pad contains a low impedance solid medium.

17. The device of claim 10, wherein the transducer includes a radiating surface defining a portion of the transducer that expels the ultrasonic energy from the transducer, and further wherein the radiating surface includes a mirrored finish.

18. A system for altering liquids comprising:
a first container sized to receive and hold liquid;
a second container configured to allow liquid from the first container to flow from the first container to the second container;
a transducer in acoustic communication with the second container, the transducer capable of producing an ultrasonic energy; and
a third container configured to allow liquid from the second container to flow from the second container to the third container.

19. The system of claim 18, further comprising:
a pump promoting flow of liquid from the first container to the second container.

20. The system of claim 18, further comprising:
a pressure gauge configured to measure pressure; and
a flow valve configured to allow adjustment of pressure.

21. The system of claim 18, wherein the transducer is coupled to the second container at an angle such that the ultrasonic energy produced by the transducer is directed in a direction deviated from the directional flow of the liquid.

22. The system of claim 18, further comprising:
an opening in the second container, the opening positioned to allow gas from within the second container to exit the second container without allowing liquid from within the second container to exit the second container.

23. The system of claim 18, further comprising:
a fourth container; and
an opening in the fourth container positioned to allow gas from within the fourth container to exit the fourth container without allowing liquid from within the fourth container to exit the fourth container.

24. The system of claim 18, further comprising:
A fourth container configured to receive an additive that introduces scent, taste, or visual characteristics to the liquid.

25. The system of claim 18, wherein the transducer is hung within the second container and makes contact with the liquid when the liquid is received within the second container.

26. The system of claim 18, further comprising:
a plurality of transducers disposed around side walls of the second container, wherein the plurality of transducers are positioned such that the ultrasonic energy from each of the plurality of transducers is directed toward the center of the second container.

27. A method of altering liquids comprising:
introducing a liquid into a vessel that is in acoustic communication with a transducer;
producing an ultrasonic energy, via the transducer, directed at least partially toward the liquid; and
allowing the ultrasonic energy to interact with the liquid within the vessel until vapor cavities are created within the liquid.

28. The method of claim 27, further comprising:
flowing the liquid through the vessel as the ultrasonic energy is produced via the transducer; and
adjusting pressure within the vessel to increase a number and a size of the vapor cavities.
